(19) United States
(12) Patent Application Publication
(10) Pub. No.: US 2025/0349910 A1
(43) Pub. Date: Nov. 13, 2025

(54) BATTERY

(71) Applicant: TOYOTA JIDOSHA KABUSHIKI KAISHA, Toyota-shi (JP)

(72) Inventor: Norihiro OSE, Nagoya-shi (JP)

(73) Assignee: TOYOTA JIDOSHA KABUSHIKI KAISHA, Toyota-shi (JP)

(21) Appl. No.: 19/042,022

(22) Filed: Jan. 31, 2025

(30) Foreign Application Priority Data
May 8, 2024 (JP) 2024-075987

(51) Int. Cl. H01M 10/42; H01M 4/139

(52) U.S. Cl. CPC H01M 10/4235; H01M 4/139; H01M 2300/0065

(57) ABSTRACT

A battery with a laminate has a first current collector layer, a first electrode active material layer, an electrolyte layer, and a second electrode active material layer laminated in this order, and at least one end of the laminate is in contact with a hard member, wherein tips of the first electrode active material layer, the electrolyte layer, and the second electrode active material layer are present inside the tip of the hard member, and a second surface of the hard member is in contact with the first electrode active material layer and/or between the surface of the second electrode active material layer and the first contact surface of the first current collector layer. An angle between a tangential direction at a tip of the second electrode active material layer and a surface direction of the first current collector layer is 60° or more and 120° or less.

### CROSS-REFERENCE TO RELATED APPLICATION

This application claims priority to Japanese Patent Application No. 2024-075987 filed on May 8, 2024, incorporated herein by reference in its entirety.

### BACKGROUND

### 1. Technical Field

The present disclosure relates to a battery.

### 2. Description of Related Art

A battery is manufactured by cutting an end portion of a laminate such as shown, for example, in Japanese Unexamined Patent Application Publication No. 2019-139921 (JP 2019-139921 A). Also, the laminate is generally manufactured by coating an electrode mixture slurry or the like on the surface of a current collector layer and forming each layer. In an electrode active material layer obtained by coating an electrode mixture slurry, an end portion of an electrode mixture slurry coating film may be wetted and expanded until the electrode mixture slurry coating film is dried, thereby causing a so-called sagging portion in the electrode active material layer. Accordingly, a manufacturing device or a coating device that suppresses the generation of a sagging portion of an electrode active material layer is known such as, for example, Japanese Unexamined Patent Application Publication No. 2022-139404 (JP 2022-139404 A) and Japanese Unexamined Patent Application Publication No. 2015-020098 (JP 2015-020098 A).

JP 2019-139921 A discloses a manufacturing method of an all-solid battery. The manufacturing method includes coating an electrode slurry on a current collector foil along a coating direction, the electrode slurry containing an electrode active material, a solid electrolyte material of a glass material, and a solvent, producing both a positive electrode and a negative electrode by performing drying, forming a solid electrolyte layer on at least one surface of the positive electrode, the negative electrode, and a carrier sheet, the solid electrode layer containing a solid electrolyte material of a glass material, forming a laminate by laminating the positive electrode and the negative electrode in a state where the solid electrolyte layer is interposed and pressing the positive electrode and the negative electrode from a lamination direction, and cutting the laminate to have a cut angle of 10° or more and 40° or less with respect to a coating direction. According to the manufacturing method of the all-solid battery of JP 2019-139921 A, wastage of material can be reduced compared to a conventional manufacturing method, the manufacturing process can be simplified, and the productivity of the all-solid battery can be improved.

JP 2022-139404 A discloses a manufacturing device of a battery having an active material paste coated on a base material, the manufacturing device including a coating portion with a discharge port that discharges an active material paste exhibiting dilatancy. The discharge port has a first reduced portion at both end portions of the discharge port in an extending direction, the first reduced portion having a length in a direction orthogonal to the extending direction that is reduced. The discharge port discharges the active material paste in a state of a low shear viscosity in a central portion positioned between the each of the first reduced portions, and the discharge port discharges the active material paste in a state of a high shear viscosity in the first reduced portion. According to the manufacturing device of a battery of JP 2022-139404 A, the utilization rate of an active material of the battery can be increased.

JP 2015-020098 A discloses a coating device including a die that has, on one end, a lip portion formed on both sides of a slit that discharges a coating liquid, the die coating the coating liquid on a foil, and a width direction of the lip portion is inclined with respect to a width direction of the foil. According to the coating device of JP 2015-020098 A, in the coating device that coats the coating liquid on the foil by the die, variations in a basis weight of a coating region due to the generation of sagging can be suppressed.

### SUMMARY

For example, when manufacturing a battery in which a first electrode active material layer, a electrolyte layer, and a second electrode active material layer are coated and laminated in order on a first current collector layer, it is necessary to coat a mixture slurry that forms each of the layers, by taking into consideration a sagging portion of each layer, in order to prevent a short circuit of the battery, specifically, in order to prevent the second electrode active material layer from coming into contact with the first current collector layer or the first electrode active material layer. In the battery, the sagging portion of each layer has a multi-stage configuration, and a volume efficiency of the battery is reduced.

In contrast to this, it can be considered to cut and remove the sagging portion of each of the electrode active material layer and the electrolyte layer, in order to improve a volume efficiency of the battery. However, in the battery, although it is desirable for the first current collector layer to extend in order to connect to the outside, there is a possibility that not only the sagging portion, but also the first current collector layer, is cut when the sagging portion is cut and removed.

Accordingly, the present disclosure has an objective to provide a battery in which a volume efficiency is improved, while leaving a first current collector layer.

The present disclosure achieves the objective, by the following measures.

### First Aspect

A battery includes a laminate in which a first current collector layer, a first electrode active material layer, an electrolyte layer, and a second electrode active material layer are laminated in an order of the first current collector layer, the first electrode active material layer, the electrolyte layer, and the second electrode active material layer, and a hard member.

On at least one end portion of the laminate,
the laminate makes contact with the hard member,
a tip of the first electrode active material layer, a tip of the electrolyte layer, and a tip of the second electrode active material layer are present further inside than a tip of the hard member, the hard member has a first surface on the first current collector layer side and a second surface facing the first surface,
the first current collector layer has a first contact surface that makes contact with the first electrode active material layer,
the second surface of the hard member makes contact with the first electrode active material layer and is present between a surface of the second electrode active material layer and the first contact surface of the first current collector layer, or the second surface of the hard member makes contact with the first electrode active material layer or is present between the surface of the second electrode active material layer and the first contact surface of the first current collector layer, and
an angle between a tangential direction at the tip of the second electrode active material layer and a surface direction of a surface of the first current collector layer is 60° or more and 120° or less.

### Second Aspect

In the battery described in the first aspect,
the tip of the second electrode active material layer is a cut surface.

### Third Aspect

In the battery described in the first aspect or the second aspect,
the tip of the second electrode active material layer and the tip of the electrolyte layer are made flush with each other.

### Fourth Aspect

In the battery described in any one of the first aspect to the third aspect,
the hard member is selected from alumina, zirconia, silicon carbide, titanium, and a combination of alumina, zirconia, silicon carbide, and titanium.

### Fifth Aspect

A manufacturing method of the battery described in any one of the first aspect to the fourth aspect includes

forming the hard member on the first current collector layer and then forming the first electrode active material layer, or simultaneously forming the hard member and the first electrode active material layer on the first current collector layer,
providing a preliminary laminate by laminating the electrolyte layer and the second electrode active material layer in an order of the electrolyte layer and the second electrode active material layer on a surface of the first electrode active material layer, and
cutting the second electrode active material layer of the preliminary laminate on the hard member and forming the laminate.

According to the battery of the present disclosure, a volume efficiency of the battery is improved, while leaving a first current collector layer.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1A is a cross-sectional schematic diagram for illustrating a battery of the present disclosure and a battery in the prior art;

FIG. 1B is a cross-sectional schematic diagram for illustrating a battery of the present disclosure and a battery in the prior art;

FIG. 2A is a schematic cross-sectional view illustrating a battery according to an embodiment of the present disclosure;

FIG. 2B is a schematic cross-sectional view illustrating a battery according to an embodiment of the present disclosure;

FIG. 3A is a schematic diagram for describing the tangent;

FIG. 3B is a schematic diagram for describing the tangent;

FIG. 4A is a schematic diagram illustrating a method of manufacturing a battery according to an embodiment of the present disclosure;

FIG. 4B is a schematic diagram illustrating a method of manufacturing a battery according to an embodiment of the present disclosure;

FIG. 4C is a schematic diagram illustrating a method of manufacturing a battery according to an embodiment of the present disclosure;

FIG. 4D is a schematic diagram illustrating a method of manufacturing a battery according to an embodiment of the present disclosure;

FIG. 5A is a schematic diagram illustrating a method of manufacturing a battery according to an embodiment of the present disclosure;

FIG. 5B is a schematic diagram illustrating a method of manufacturing a battery according to an embodiment of the present disclosure;

FIG. 5C is a schematic diagram illustrating a method of manufacturing a battery according to an embodiment of the present disclosure;

FIG. 5D is a schematic diagram illustrating a method of manufacturing a battery according to an embodiment of the present disclosure;

FIG. 6A is a schematic diagram illustrating a method of manufacturing a battery according to an embodiment of the present disclosure;

FIG. 6B is a schematic diagram for illustrating a process for manufacturing a battery of the present disclosure; and

FIG. 6C is a schematic diagram illustrating a method of manufacturing a battery according to an embodiment of the present disclosure.

### DETAILED DESCRIPTION OF EMBODIMENTS

Hereinafter, embodiments of the present disclosure will be described in detail. Note that the present disclosure is not limited to the following embodiments, and various modifications can be made within the scope of the gist of the present disclosure. In the description of the drawings, the same elements are denoted by the same reference numerals, and redundant description will be omitted.

### Battery; First Aspect

The battery of the present disclosure comprises:

a laminate in which a first current collector layer, a first electrode active material layer, an electrolyte layer, and a second electrode active material layer are laminated in order, and a hard member, in which
on at least one end portion of the laminate,
the laminate makes contact with the hard member,
a tip of the first electrode active material layer, a tip of the electrolyte layer, and a tip of the second electrode active material layer are present further inside than a tip of the hard member, the hard member has a first surface on the first current collector layer side and a second surface facing the first surface,
the first current collector layer has a first contact surface that makes contact with the first electrode active material layer,
The second surface of the hard member is in contact with the first electrode active material layer, and
The angle between the tangential direction at the tip of the second electrode active material layer and the surface direction of the surface of the first current collector layer is 60° or more and 120° or less.

According to the battery of the present disclosure, a volume efficiency of the battery is improved, while leaving a first current collector layer.

Without being limited by theory, in the battery of the present disclosure, the first electrode active material layer is present on the hard member. Thus, for example, when the sagging portion of the electrode active material layer or the like is vertically cut and removed from the surface of the second electrode active material layer, the first current collector layer is not cut due to the presence of the hard member. Thereby, the volume efficiency of the battery is improved while leaving the first current collector layer.

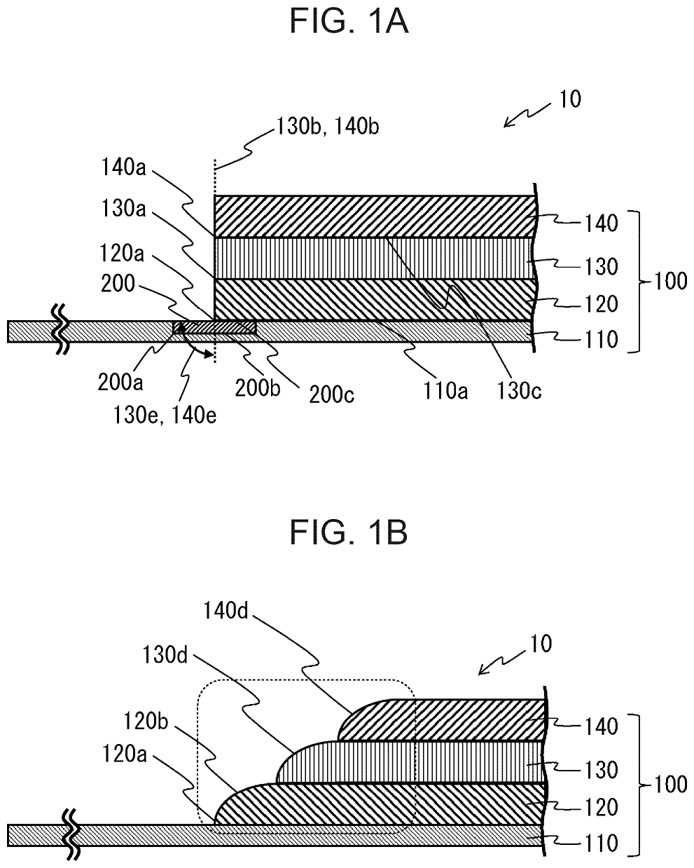

FIG. 1A is a schematic cross-sectional view of a battery according to an embodiment of the present disclosure. FIG. 1B is a schematic cross-sectional view showing one embodiment of a battery according to the prior art.

The battery 10 illustrated in FIG. 1A includes a laminate 100 in which a first current collector layer 110, a first electrode active material layer 120, an electrolyte layer 130, and a second electrode active material layer 140 are stacked in this order. At one end of the laminate 100, the laminate 100 is in contact with the hard member 200. Further, the tip 120a of the first electrode active material layer, the tip 130a of the electrolyte layer, and the tip 140a of the second electrode active material layer are located inside the tip 200a of the hard member. The hard member 200 has a first surface 200b facing the first current collector layer 110 and a second surface 200c facing the first surface 200b. In the battery 10 illustrated in FIG. 1A, the second surface 200c of the hard member 200 contacts the first electrode active material layer 120, and the angle 140e between the tangential 140b direction at the tip of the second electrode active material layer and the surface direction of the surface of the first current collector layer 110 is perpendicular. As shown in FIG. 1A, there is a first electrode active material layer 120 on the hard member 200. Thus, for example, when the sagging portion such as the electrode active material layer is vertically cut and removed from the surface of the second electrode active material layer on the hard member, the first current collector layer 110 is not cut because the hard member is present. Thereby, the volume efficiency of the battery is improved while leaving the first current collector layer.

The battery in the prior art illustrated in FIG. 1B is, for example, a battery obtained when an electrode mixture slurry or a solid electrolyte mixture slurry is sequentially applied and dried to form a laminate, and each layer has a sagging portion. Specifically, the battery 10 illustrated in FIG. 1B includes a laminate 100 in which a first current collector layer 110, a first electrode active material layer 120, an electrolyte layer 130, and a second electrode active material layer 140 are stacked in this order. The end surface 120b of the first electrode active material layer forms an inclined surface that approaches the first current collector layer 110 toward the tip 120a of the first electrode active material layer. The end surface 130d of the electrolyte layer and the end surface 140d of the second electrode active material layer form the same inclined surface as the end surface 120b of the first electrode active material layer. Each inclined surface is formed in a stepped shape to form a so-called sagging portion (a dotted line frame portion illustrated in FIG. 1B). Since the sagging portion is present, the volume efficiency of the battery is lowered. When the sagging portion is cut and removed, the first current collector layer 110 may be cut.

Battery; second aspect
The battery of the present disclosure comprises:
a laminate in which a first current collector layer, a first electrode active material layer, an electrolyte layer, and a second electrode active material layer are laminated in order, and a hard member, in which
on at least one end portion of the laminate,
the laminate makes contact with the hard member,
a tip of the first electrode active material layer, a tip of the electrolyte layer, and a tip of the second electrode active material layer are present further inside than a tip of the hard member, the hard member has a first surface on the first current collector layer side and a second surface facing the first surface,
the first current collector layer has a first contact surface that makes contact with the first electrode active material layer,
The second surface of the hard member is between a surface of the second electrode active material layer and the first contact surface of the first current collector layer; and
The angle between the tangential direction at the tip of the second electrode active material layer and the surface direction of the surface of the first current collector layer is 60° or more and 120° or less.

According to the battery of the present disclosure, a volume efficiency of the battery is improved, while leaving a first current collector layer.

Without being limited by theory, in the battery of the present disclosure, the hard member is in contact with the laminate at a predetermined position. Thus, for example, when the sagging portion of the electrode active material layer or the like is cut and removed from the surface of the second electrode active material layer, the cutting stop position is controlled by the position of the second surface of the hard member, and the first current collector layer existing below the hard member is not cut. Thereby, the volume efficiency of the battery is improved while leaving the first current collector layer.

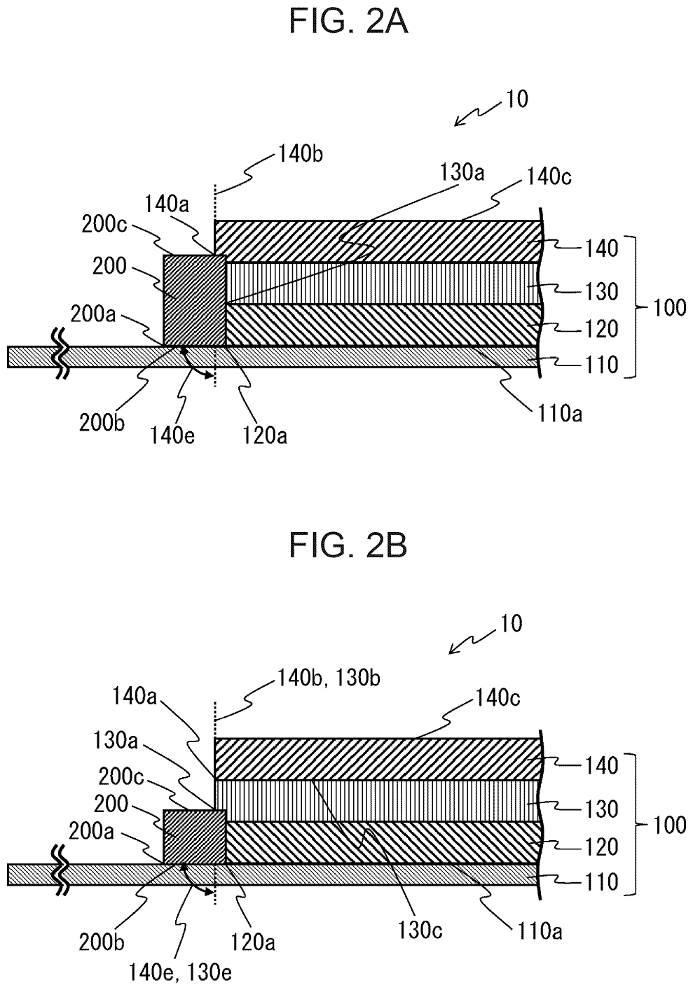

FIG. 2A is a schematic cross-sectional view of a battery according to an embodiment of the present disclosure.

The battery 10 illustrated in FIG. 2A has a laminate 100 with the laminate 100 contacting the hard member 200 at one end of the laminate 100. The first current collector layer 110 has a first contact surface 110a in contact with the first electrode active material layer 120. In the battery 10 illustrated in FIG. 2A, the second surface 200c of the hard member 200 is present between the surface 140c of the second electrode active material layer and the first contact surface 110a of the first current collector layer 110, and more specifically, is present in the second electrode active material layer 140. The angle 140e between the tangential 140b direction at the tip of the second electrode active material layer and the surface direction of the surface of the first current collector layer 110 is perpendicular. In the battery 10 shown in FIG. 2A, the hard member 200 contacts the laminate 100 in place. Thus, for example, when the sagging portion of the electrode active material layer or the like is vertically cut and removed from the surface of the second electrode active material layer on the hard member, the sagging portion of the second electrode active material layer 140 is cut, and the first current collector layer 110 existing below the hard member 200 is not cut. Thereby, the volume efficiency of the battery is improved while leaving the first current collector layer.

The battery of the present disclosure is not particularly limited.

The electrolyte layer has a second contact surface in contact with the second electrode active material layer, and
A second surface of the hard member may be present between the second contact surface of the electrolyte layer and the first contact surface of the first current collector layer.

FIG. 2B is a schematic cross-sectional view of a battery according to an embodiment of the present disclosure.

The battery 10 illustrated in FIG. 2B has a laminate 100 with the laminate 100 contacting the hard member 200 at one end of the laminate 100. The electrolyte layer 130 has a second contact surface 130c in contact with the second electrode active material layer 140. In the battery 10 illustrated in FIG. 2B, a second surface 200c of the hard member 200 is present between the second contact surface 130c of the electrolyte layer 130 and the first contact surface 110a of the first current collector layer 110, and more specifically, is present in the electrolyte layer 130. In the battery 10 shown in FIG. 2B, the hard member 200 contacts the laminate 100 in place. Thus, for example, when the sagging portion such as the electrode active material layer is vertically cut and removed from the surface of the second electrode active material layer on the hard member, the sagging portion of the second electrode active material layer 140 and the sagging portion of the electrolyte layer 130 are cut, and the first current collector layer 110 existing below the hard member 200 is not cut. Thereby, the volume efficiency of the battery is improved while leaving the first current collector layer.

### Shape of the Laminate

In the laminated body, the first current collector layer, the first electrode active material layer, the electrolyte layer, and the second electrode active material layer are laminated in this order. Hereinafter, the shape of each layer constituting the laminate will be described.

In the battery of the present disclosure, the first current collector layer is not particularly limited, but may extend beyond the first electrode active material layer, the electrolyte layer, and the second electrode active material layer.

In the laminate 100 of the above-described FIG. 1A, the first current collector layer 110, the first electrode active material layer 120, the electrolyte layer 130, and the second electrode active material layer 140 are laminated in this order. The first current collector layer 110 extends beyond the first electrode active material layer 120, the electrolyte layer 130, and the second electrode active material layer 140.

In the battery of the present disclosure, the tip of the second electrode active material layer is not particularly limited, but may be a cut surface. The tip of the electrolyte layer is not particularly limited, but may be a cut surface. Further, the tip of the first electrode active material layer is not particularly limited, but may be a cut surface.

In the above-described FIG. 1A, the tip 140a of the second electrode active material layer, the tip 130a of the electrolyte layer, and the tip 120a of the first electrode active material layer may each be a cut surface. The battery in which the end face of each layer is a cut surface can be obtained, for example, by vertically cutting and removing a sagging portion such as an electrode active material layer from the surface of the second electrode active material layer on the hard member. The same applies to the illustrated FIG. 2A and FIG. 2B.

In the battery of the present disclosure, the tip of the second electrode active material layer and the tip end of the electrolyte layer are not particularly limited, but may be flush with each other. The tip of the electrolyte layer and the tip of the first electrode active material layer are not particularly limited, but may be flush with each other.

In the above-described FIG. 1A, the tip 140a of the second electrode active material layer and the tip 130a of the electrolyte layer are flush with each other. The tip 130a of the electrolyte layer and the tip 120a of the first electrode active material layer are flush with each other. The battery in which the end face of each layer is flush can be obtained, for example, by vertically cutting and removing a sagging portion such as an electrode active material layer from the surface of the second electrode active material layer on the hard member.

In the battery of the present disclosure, the angle between the tangential direction at the tip of the second electrode active material layer and the surface direction of the surface of the first current collector layer is 60° or more and 120° or less. The angle is not particularly limited, but may be 60° or more, 65° or more, 70° or more, 75° or more, 80° or more, 85° or more, or 90° or more. The angle may be less than or equal to 120°, less than or equal to 115°, less than or equal to 110°, less than or equal to 105°, less than or equal to 100°, less than or equal to 95° or less than or equal to 90°.

In the above-described FIG. 1A, the angle 140e is an angle formed by the tangential 140b direction at the tip of the second electrode active material layer and the surface direction of the surface of the first current collector layer 110. Note that the “tangent line” in the present disclosure will be described later.

In the battery of the present disclosure, the angle between the tangent line at the tip of the electrolyte layer and the surface direction of the surface of the first current collector layer is not particularly limited, but may be 60° or more, 65° or more, 70° or more, 75° or more, 80° or more, 85° or more, or 90° or more. The angle between the tangent at the tip of the electrolyte layer and the surface direction of the surface of the first current collector layer may be 120° or less, 115° or less, 110° or less, 105° or less, 100° or less, 95° or less, or 90° or less.

In the above-described FIG. 2B, the angle 130e is an angle formed by the tangential 130b direction at the tip of the electrolyte layer and the surface direction of the surface of the first current collector layer 110. Note that the “tangent line” in the present disclosure will be described later.

In the present disclosure, “tangent line” means a tangent line in a cross section perpendicular to the surface direction of each layer and perpendicular to the line formed by the tip of each layer.

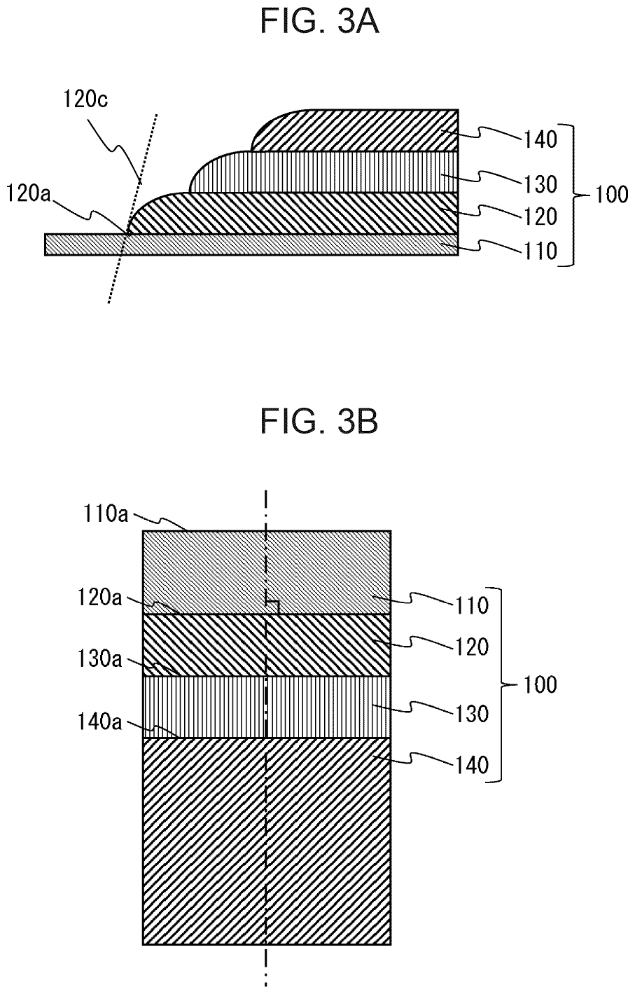

FIG. 3A and FIG. 3B are schematic illustrations for describing “tangents,” but are not limited thereto. FIG. 3B is a schematic view of FIG. 3A as viewed from the front side of the second electrode active material layer.

For example, the tangent 120c of the first electrode active material layer illustrated by a dotted line in FIG. 3A is a cross section perpendicular to the surface direction of the first electrode active material layer 120 and perpendicular to the line formed by the tip 120a of the first electrode active material layer, specifically, a tangent line in a cross section cut at a cutting position illustrated by a dashed-dotted line in FIG. 3B. The same applies to the tangent lines of the other layers.

### Method for Manufacturing Battery; First Aspect

The battery of the present disclosure can be manufactured by a manufacturing method including the following steps:

Forming the hard member on the surface of the first current collector layer, then forming the first electrode active material layer,
providing a preliminary laminate by laminating the electrolyte layer and the second electrode active material layer in order on a surface of the first electrode active material layer, and cutting the second electrode active material layer of the preliminary laminate on the hard member and forming the laminate.

According to the battery manufacturing method of the present disclosure, it is possible to manufacture a battery with improved volume efficiency while leaving the first current collector layer.

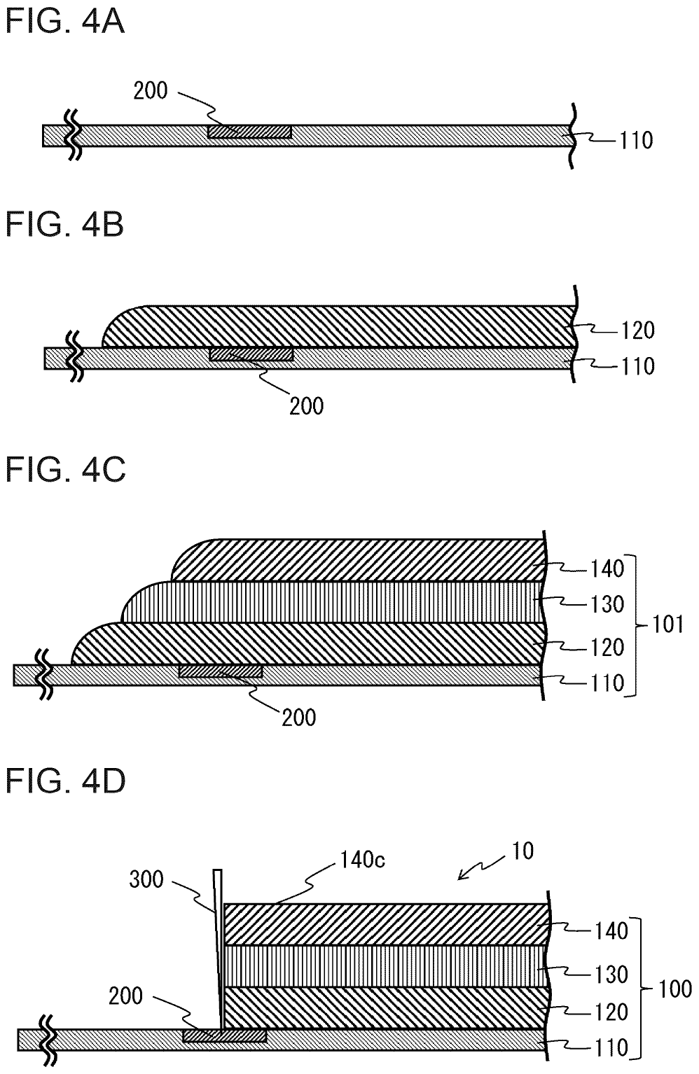

FIG. 4A to FIG. 4D are schematic illustrations illustrating one embodiment of the disclosed methods of manufacturing a battery, but are not limited thereto.

First, as shown in FIG. 4A, the surface of the first current collector layer 110 is processed to form the hard member 200. Next, as illustrated in FIG. 4B, the first electrode active material layer 120 is formed so as to cover at least a part of the hard member 200. Then, as shown in FIG. 4C, the electrolyte layer 130 and the second electrode active material layer 140 are stacked in this order on the first electrode active material layer 120 to form the preliminary laminate 101. Then, on the hard member 200, the second electrode active material layer 140 and the electrolyte layer 130 of the preliminary laminate 101 are vertically cut from the surface 140c of the second electrode active material layer by using the cutting blade 300 to form the laminate 100. Due to the presence of the hard member, for example, even when the sagging portion of the electrode active material layer or the like is cut and removed, the first current collector layer is not cut, whereby a battery with improved volume efficiency can be manufactured while leaving the first current collector layer.

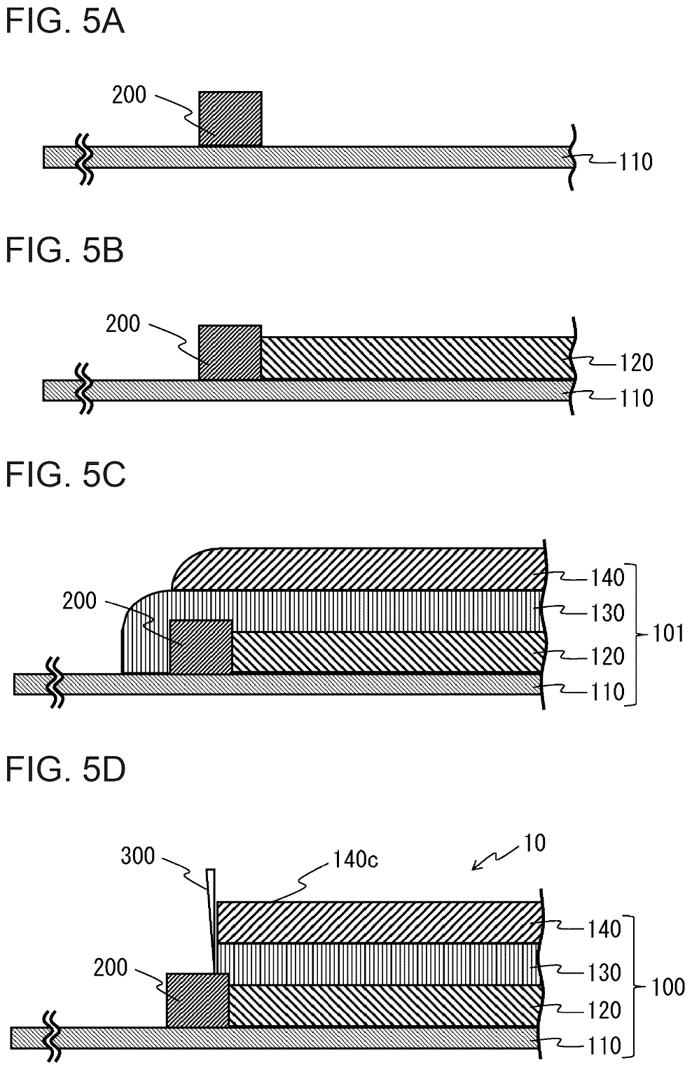

FIG. 5A to FIG. 5D are schematic illustrations illustrating one embodiment of the disclosed methods of manufacturing a battery, but are not limited thereto.

First, as illustrated in FIG. 5A, the hard member 200 is formed by applying a slurry including, for example, a hard member to the top surface of the first current collector layer 110. Next, the first electrode active material layer 120 is formed in contact with the hard member 200. Then, as illustrated in FIG. 5C, the electrolyte layer 130 and the second electrode active material layer 140 are stacked in this order on the first electrode active material layer 120 to form the preliminary laminate 101. Then, on the hard member 200, the second electrode active material layer 140 and the electrolyte layer 130 of the preliminary laminate 101 are vertically cut from the surface 140c of the second electrode active material layer by using the cutting blade 300 to form the laminate 100. Due to the presence of the hard member, for example, even when the sagging portion of the electrode active material layer or the like is cut and removed, the first current collector layer is not cut, whereby a battery with improved volume efficiency can be manufactured while leaving the first current collector layer.

### Method for Manufacturing Battery; Second Aspect

The battery of the present disclosure can be manufactured by a manufacturing method including the following steps:

Forming the hard member and the first electrode active material layer on the surface of the first current collector layer at the same time,
providing a preliminary laminate by laminating the electrolyte layer and the second electrode active material layer in order on a surface of the first electrode active material layer, and cutting the second electrode active material layer of the preliminary laminate on the hard member and forming the laminate.

According to the battery manufacturing method of the present disclosure, it is possible to manufacture a battery with improved volume efficiency while leaving the first current collector layer.

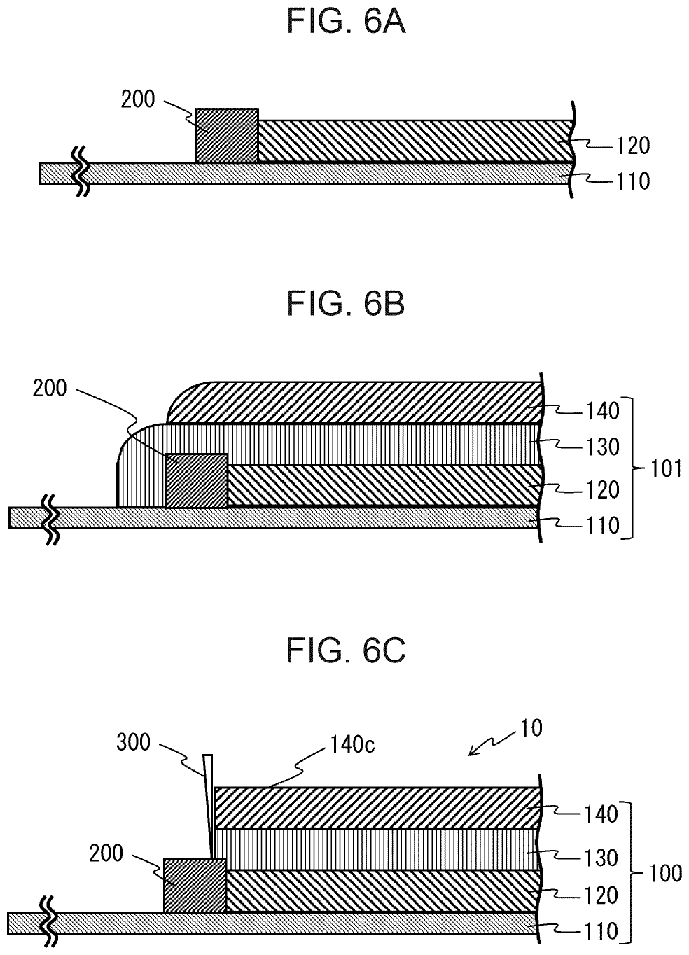

FIG. 6A to FIG. 6C are schematic illustrations illustrating one embodiment of the disclosed methods of manufacturing a battery, but are not limited thereto.

First, as shown in FIG. 6A, a slurry including a hard member and a mixture slurry forming a first electrode active material are simultaneously applied to the top surface of the first current collector layer 110, thereby simultaneously forming the hard member 200 and the first electrode active material layer 120. Next, as shown in FIG. 6B, the electrolyte layer 130 and the second electrode active material layer 140 are stacked in this order on the first electrode active material layer 120 to form the preliminary laminate 101. Then, on the hard member 200, the second electrode active material layer 140 and the electrolyte layer 130 of the preliminary laminate 101 are vertically cut from the surface 140c of the second electrode active material layer by using the cutting blade 300 to form the laminate 100. Due to the presence of the hard member, for example, even when the sagging portion of the electrode active material or the like is cut and removed, the first current collector layer is not cut, whereby a battery with improved volume efficiency can be manufactured while leaving the first current collector layer.

### Method for Forming Hard Member

The method of forming the hard member is not particularly limited. For example, as a method of forming a hard member, a method of forming a hard member by applying a slurry containing a hard member to the surface of the first current collector layer, a method of forming by transferring a hard member to the surface of the first current collector layer, a method of forming by electrostatically applying a hard member to the surface of the first current collector layer, etching the first current collector layer, and then inserting the hard member can be exemplified, but is not limited thereto.

### Method for Cutting a Preliminary Laminate

The method of cutting the preliminary electrode laminate is not particularly limited, but may be a method of cutting using a cutting blade or the like, but is not limited to this case.

Battery and method of manufacturing battery; respective components

Hereinafter, each configuration of a battery and a method of manufacturing the battery will be described.

The battery of the present disclosure may be a liquid-based battery containing an electrolyte solution as an electrolyte layer, or may be a solid-state battery having a solid electrolyte layer as an electrolyte layer. In the context of the present disclosure, a “solid battery” means a battery using at least a solid electrolyte as an electrolyte, and therefore a solid battery may use a combination of a solid electrolyte and a liquid electrolyte as an electrolyte. Further, the battery of the present disclosure may be an all-solid-state battery, that is, a battery using only a solid electrolyte as an electrolyte.

In the context of the present disclosure, a “mixture” means a composition capable of forming a positive electrode active material layer or the like as it is or by further containing other components. In addition, in the context of the present disclosure, the “mixture slurry” means a slurry that includes a dispersion medium in addition to the “mixture” and that can be applied and dried to form a positive electrode active material layer or the like.

The battery of the present disclosure includes a hard member.

### Hard Member

In the present disclosure, the hard member is not particularly limited. Examples of the material of the hard member include, but are not limited to, a material selected from alumina, zirconia, silicon carbide, titanium, and a combination thereof. The material of the hard member is not particularly limited, but from the viewpoint of forming the hard member by coating, it is preferable that the hard member is made of a material such as alumina that can be easily granulated.

The hard member can be formed, for example, by coating a slurry including the hard member as described above. The slurry containing the hard member is not particularly limited, but may contain a binder. The binder is preferably a material that does not react with the solid electrolyte. Examples of such materials include, but are not limited to, polyvinylidene fluoride (PVDF), acrylic-butadiene rubber (ABR), styrene-butadiene rubber (SBR), and the like.

Assuming that the entire slurry containing the hard member is 100% by mass, the content of the hard member is not particularly limited, but may be 1% by mass or more, 5% by mass or more, or 10% by mass or more, and may be 99% by mass or less, 95% by mass or less, or 90% by mass or less.

The Young's modulus of the hard member is not particularly limited. From the viewpoint of protecting the first current collector layer with respect to the first electrode active material layer, the Young's modulus of the hard member may be 5 times or more, 6 times or more, or 7 times or more. From the viewpoint of preventing wear of the cutting blade, the Young's modulus of the hard member may be 10 times or less, 9 times or less, or 8 times or less. The Young's modulus can be determined in accordance with JISK7161-1 (2014).

From the viewpoint of protecting the first current collector layer with respect to the second electrode active material layer, the Young's modulus of the hard member may be 5 times or more, 6 times or more, or 7 times or more. From the viewpoint of preventing wear of the cutting blade, the Young's modulus of the hard member may be 10 times or less, 9 times or less, or 8 times or less. The Young's modulus can be determined in accordance with JISK7161-1 (2014).

In the battery of the present disclosure, in the laminated body, the first current collector layer, the first electrode active material layer, the electrolyte layer, and the second electrode active material layer are laminated in this order. The laminate is not particularly limited, but may have a second current collector layer. The laminate is not particularly limited. In detail, in the laminate, the first current collector layer, the first electrode active material layer, the electrolyte layer, and the 2 electrode active material layer may be laminated in this order, the second electrode active material layer, the electrolyte layer, the first electrode active material layer, the first current collector layer, the first electrode active material layer, the electrolyte layer, and the second electrode active material layer may be laminated in this order, the first current collector layer, the first electrode active material layer, the electrolyte layer, the second electrode active material layer, and the second current collector layer may be laminated in this order, or the second current collector layer, the second electrode active material layer, the electrolyte layer, the first electrode active material layer, the first current collector layer, the first electrode active material layer, the electrolyte layer, the second electrode active material layer, and the second current collector layer may be laminated in this order. First current collector layer

The first current collector layer may be a negative electrode current collector layer or a positive electrode current collector layer. The first current collector layer is not particularly limited, but is preferably a negative electrode current collector layer.

Examples of the material used for the first current collector layer include, but are not limited to, Cu, Ni, Cr, Au, Pt, Ag, Al, Fe, Ti, Zn, Co, and stainless steel. The shape of the first current collector layer may be, for example, a foil shape, a plate shape, a mesh shape, or the like.

### First Electrode Active Material Layer

The first electrode active material layer includes at least an electrode active material, and may further optionally include a solid electrolyte, a conductive auxiliary agent, a binder, and the like. When the first electrode active material layer is a positive electrode active material layer, the first electrode active material layer includes a positive electrode active material as an electrode active material. When the first electrode active material layer is a negative electrode active material layer, the first electrode active material layer includes a negative electrode active material as an electrode active material. The first electrode active material layer is not particularly limited, but is preferably a negative electrode active material layer.

### Positive Electrode Active Material

Examples of the positive electrode active material may include, but are not limited to, lithium cobaltate (LiCoO₂), lithium manganate (LiMn₂O₄), and lithium nickel-cobalt-manganate (NCM: LiCO_{1/3}Ni_{1/3}Mn_{1/3}O₂). The shape of the positive electrode active material may be, for example, particulate. Negative active material

The material of the negative electrode active material is not particularly limited, and may be metallic lithium or a material capable of occluding and releasing metallic ions such as lithium ions. Examples of the material capable of occluding and releasing metal ions such as lithium ions include, but are not limited to, alloy-based negative electrode active materials such as Si and Sn, carbon materials such as graphite, and lithium titanate (Li₄Ti₅O₁₂). The shape of the negative electrode active material may be, for example, a particulate shape or a sheet shape.

### Solid Electrolyte

The material of the solid electrolyte is not particularly limited, but may be a sulfide solid electrolyte, an oxide solid electrolyte, a polymer electrolyte, or the like. Examples of the sulfide solid electrolyte include Li₂S-P₂S₅ system (Li₇P₃S₁₁, Li₃PS₄, Li₈P₂S₉, etc.), but are not limited to these cases. Examples of the oxide solid-state electrolyte include, but are not limited to, Li₇La₃Zr₂O₁₂, Li₇₋ₓLa₃Zr₁₋ₓNbₓO₁₂, and the like. Examples of the polymer electrolyte include, but are not limited to, polyethylene oxide (PEO) and the like.

### Conductive Aid

The conductive aid may be, for example, but not limited to, vapor grown carbon fiber (VGCF), acetylene black (AB), Ketjen black (KB), and the like.

### Binder

The binder may be, for example, but not limited to, polyvinylidene fluoride (PVdF), styrene-butadiene rubber (SBR), and the like.

### Electrolyte Layer-Solid Electrolyte Layer

The battery of the present disclosure may have a solid electrolyte layer as a solid battery, i.e., an electrolyte layer. The solid electrolyte layer includes at least a solid electrolyte, and may optionally include a conductive auxiliary agent, a binder, and the like. For the solid electrolyte, the conductive auxiliary agent, and the binder, reference can be made to the description of “first electrode active material layer”.

### Electrolyte Layer-Separator Layer

The battery of the present disclosure may have a liquid-based battery, i.e., an electrolyte retained in an electrolyte, in particular a separator layer, as an electrolyte layer.

### Electrolytic Solution

The electrolyte solution is not particularly limited, but preferably contains a supporting salt and a solvent. Examples of the support salt may include, but are not limited to, LiPF₆, LiCF₃SO₂. Examples of solvents used in the electrolyte may include, but are not limited to, ethylene carbonate (EC), diethyl carbonate (DEC), and the like.

### Separator

Examples of the separator may include, but are not limited to, polyolefin-based, polyamide-based, and polyimide-based nonwoven fabrics.

### Second Electrode Active Material Layer

The second electrode active material layer includes at least an electrode active material, and may further optionally include a solid electrolyte, a conductive auxiliary agent, a binder, and the like. When the first electrode active material layer is a positive electrode active material layer, the second electrode active material layer includes a negative electrode active material as an electrode active material. When the first electrode active material layer is a negative electrode active material layer, the second electrode active material layer includes a positive electrode active material as an electrode active material. The second electrode active material layer is not particularly limited, but is preferably a positive electrode active material layer.

For the electrode active material, the solid electrolyte, the conductive auxiliary agent, and the binder that can be included in the second electrode active material layer, reference can be made to the description of “first electrode active material layer” above.

### Second Current Collector Layer

The first current collector layer may be a negative electrode current collector layer or a positive electrode current collector layer. The second current collector layer is not particularly limited, but is preferably a positive electrode current collector layer. For the material used for the second current collector layer, reference can be made to the description of “first current collector layer”.

### Battery Applications, etc.

The battery in the present disclosure is not particularly limited, but may be a lithium ion secondary battery. The battery in the present disclosure may be, for example, an in-vehicle battery, or may be used as a power source for a moving object (for example, a railway, a ship, or an aircraft) other than a vehicle, or may be used as a power source for an electric product such as an information processing apparatus.

While embodiments of the battery of the present disclosure have been described, those skilled in the art will recognize that changes can be made without departing from the scope of the claims.

What is claimed is:

1. A battery comprising:
a laminate in which a first current collector layer, a first electrode active material layer, an electrolyte layer, and a second electrode active material layer are laminated in an order of the first current collector layer, the first electrode active material layer, the electrolyte layer, and the second electrode active material layer; and a hard member, wherein
on at least one end portion of the laminate,
the laminate makes contact with the hard member,
a tip of the first electrode active material layer, a tip of the electrolyte layer, and a tip of the second electrode active material layer are present further inside than a tip of the hard member,
the hard member has a first surface on the first current collector layer side and a second surface facing the first surface,
the first current collector layer has a first contact surface that makes contact with the first electrode active material layer,
the second surface of the hard member makes contact with the first electrode active material layer and is present between a surface of the second electrode active material layer and the first contact surface of the first current collector layer, or the second surface of the hard member makes contact with the first electrode active material layer or is present between the surface of the second electrode active material layer and the first contact surface of the first current collector layer, and
an angle between a tangential direction at the tip of the second electrode active material layer and a surface direction of a surface of the first current collector layer is 60° or more and 120° or less.

2. The battery according to claim 1, wherein the tip of the second electrode active material layer is a cut surface.

3. The battery according to claim 1, wherein the tip of the second electrode active material layer and the tip of the electrolyte layer are made flush with each other.

4. The battery according to claim 1, wherein the hard member is selected from alumina, zirconia, silicon carbide, titanium, and a combination of alumina, zirconia, silicon carbide, and titanium.

5. A manufacturing method of the battery according to claim 1, the manufacturing method comprising:
forming the hard member on the first current collector layer and then forming the first electrode active material layer, or simultaneously forming the hard member and the first electrode active material layer on the first current collector layer;
providing a preliminary laminate by laminating the electrolyte layer and the second electrode active material layer in an order of the electrolyte layer and the second electrode active material layer on a surface of the first electrode active material layer; and
cutting the second electrode active material layer of the preliminary laminate on the hard member and forming the laminate.
